(19) United States
(12) Patent Application Publication
(10) Pub. No.: US 2020/0265515 A1
(43) Pub. Date: Aug. 20, 2020

(54) FRAMEWORK FOR DIGITAL ASSET LENDING AND HEDGING USING STABLE COIN

(71) Applicant: DLCC, LLC, Staten Island, NY (US)

(72) Inventors: James A. Runnels, Staten Island, NY (US); Darren Wolfberg, Chappaqua, NY (US)

(21) Appl. No.: 16/789,637

(22) Filed: Feb. 13, 2020

Related U.S. Application Data
(60) Provisional application No. 62/805,555, filed on Feb. 14, 2019.

(51) Int. Cl. G06Q 40/02; G06Q 20/06; G06Q 40/04; G06Q 20/38; G06Q 20/12; G06Q 20/36; G06F 21/60; H04L 9/06

(52) U.S. Cl. CPC G06Q 40/025; G06Q 20/0655; G06Q 40/04; G06Q 20/381; H04L 2209/56; G06Q 20/3672; G06F 21/602; H04L 9/0637; G06Q 2220/00; G06Q 20/127

(57) ABSTRACT

Disclosed is a digital asset lending system for lending and hedging digital assets using cryptocurrency comprising an aggregation module to aggregate inventory accounts of the digital assets provided by lenders; a display module to display the aggregate inventory accounts associated with the lenders; a request generation module to enable a borrower to enter data associated with a borrow; an order execution module to execute a short sale of the aggregate inventory accounts when the at least one received minimum required collateral is converted into the cryptocurrency of an equivalent value; a delivery module to deliver a generated short sale proceeds of the short sale of the aggregate inventory accounts to a compliance admin; a short cover module to execute a short cover buy order to buy back the shorted aggregate inventory accounts; and a margin maintenance module to display a margin timer representing a time left to maintain a margin.

### CROSS-REFERENCE TO RELATED APPLICATION

This application claims the benefit of U.S. Provisional Patent Application Ser. No. 62/805,555, entitled “FRAMEWORK FOR DIGITAL ASSET LENDING AND HEDGING USING STABLE COIN”, filed on Feb. 14, 2019, the entire content of which is hereby incorporated by reference in its entirety.

### BACKGROUND

### Field of Invention

Embodiments disclosed herein relate, in general, to methods and systems for lending digital assets for short sale, and, more particularly, to methods and systems for lending digital assets using a collateral in the form of cryptocurrency.

### Description of Related Art

While trading in stocks and securities, a short sale is a transaction in which a borrowing individual or an institutional investor borrows digital and/or traditional assets such as, stocks or securities from a lender in order to sell the borrowed assets in anticipation that the price of the assets can fall in future, as compared to a current market price. The borrowing individual can then initiate a short covering by buying back the digital assets at a lower price to earn a profit that can then be calculated as a difference between the short sale price and the buy-back price. However, in some cases the anticipated price of the assets may increase, thus causing a loss to the borrowing user. Further, the borrowing user can return the digital assets to the lender of the digital assets. Moreover, the borrowing user can pay a lending return corresponding to the interest charged by the lender of the digital assets.

Conventionally, before executing a short sale of the digital assets, the borrowing user has to locate the digital assets to borrow, for which the borrowing user has to contact a Broker-Dealer. The Broker Dealer provides a locate to the inquiring party if there is available supply that is aggregated from lenders. All such operations in performing the short sale of the digital assets are regulated and financial institutions are bound to follow such regulations, which is not seen with currently available solutions in digital assets. Additionally, the market structure of digital assets vs. traditional assets are different to the extent that if you want an exchange execution, you have to execute at the location of your custodian partner. Moreover, the collateral, required for borrowing the digital assets, is regulated according to Regulation T that is not being followed in the currently available solutions a a short sale for mitigating a risk of loss is not being effected today, limiting traditional participants from entering the market.

Thus, there is a need for a system and a method to regulate the foregoing established relationships between lenders, the disadvantaged borrowing users, custody providers, collateral managers and exchanges. Also, to provide an availability of more competitive borrowing rates and collateral requirements that are in compliance with the available regulations.

### SUMMARY

Embodiments in accordance with the present invention provide a digital asset lending system for lending and hedging one or more digital assets using a fiat money or a cryptocurrency. The digital asset lending system comprising an aggregation module configured to aggregate a plurality inventory accounts of the one or more digital assets provided by a plurality of lenders. The digital asset lending system comprising a display module configured to display the plurality of aggregate inventory accounts associated with the plurality of lenders on a borrower dashboard based on a match between a location of the borrower and a location of each of the plurality of lenders. The digital asset lending system comprising a request generation module configured to enable a borrower to enter data associated with a borrow when a minimum required collateral to borrow at least one of the plurality of aggregate inventory accounts is received. The digital asset lending system comprising an order execution module configured to execute a short sale of digital assets from one or more of the plurality of aggregate inventory accounts in response to an activation of a one-click tab provided on the borrower dashboard when the received minimum required collateral is converted into the cryptocurrency of an equivalent value. The digital asset lending system comprising a delivery module configured to deliver a generated short sale proceeds of the short sale of the at least one of the plurality of aggregate inventory accounts to a collateral manager and a compliance admin, wherein the short sale proceeds are converted into a fiat currency of an equivalent value or a cryptocurrency of an equivalent value. The digital asset lending system comprising a short cover module configured to execute at least one short cover buy order corresponding to the executed short sale to buy back the aggregate inventory accounts sold during the short sale. The digital asset lending system comprising a margin maintenance module configured to display, on the borrower dashboard, a margin timer representing a time left to maintain a margin in a master account of the borrower when a margin call is initiated.

Embodiments in accordance with the present invention provide a digital asset lending system for lending and hedging one or more digital assets using a fiat money or a cryptocurrency. The digital asset lending system comprising an aggregation module configured to aggregate a plurality inventory accounts of the one or more digital assets provided by a plurality of lenders. The digital asset lending system comprising a display module configured to display the plurality of aggregate inventory accounts associated with the plurality of lenders on a borrower dashboard based on a match between a location of the borrower and a location of each of the plurality of lenders. The digital asset lending system comprising a request generation module configured to enable a borrower to enter data associated with a borrow when a minimum required collateral to borrow at least one of the plurality of aggregate inventory accounts is received, wherein the minimum required collateral is one of a 50%, a 15%, a 120% of a total borrow amount. The digital asset lending system comprising an order execution module configured to execute a short sale of digital assets from one or more of the plurality of aggregate inventory accounts in response to an activation of a one-click tab provided on the borrower dashboard when the at least one received minimum required collateral is converted into the cryptocurrency of an equivalent value. The digital asset lending system comprising a delivery module configured to deliver a generated short sale proceeds of the short sale of the at least one of the plurality of aggregate inventory accounts to a compliance admin, wherein the short sale proceeds are converted into the cryptocurrency of the equivalent value. The digital asset lending system comprising a short cover module configured to execute at least one short cover buy order corresponding to the executed short sale to buy back the aggregate inventory accounts sold during the short sale. The digital asset lending system comprising a margin maintenance module configured to display, on the borrower dashboard, a margin timer representing a time left to maintain a margin in a master account of the borrower when a margin call is initiated.

Embodiments of the present invention may provide a method for lending and hedging one or more digital assets using a fiat money or a cryptocurrency. The method comprising steps of: aggregating a plurality inventory accounts of the one or more digital assets provided by a plurality of lenders; displaying a plurality of aggregate inventory accounts associated with the plurality of lenders on a borrower dashboard based on match between a location of the borrower and a location of each of the plurality of lenders; enabling a borrower to enter data associated with a borrow when a minimum required collateral to borrow at least one of the plurality of aggregate inventory accounts is received; executing a short sale of digital assets from one or more of the plurality of aggregate inventory accounts in response to an activation of a one-click tab provided on the borrower dashboard when the at least one received minimum required collateral is converted into a cryptocurrency of an equivalent value; delivering a generated short sale proceeds of the short sale of the at least one of the plurality of aggregate inventory accounts to a compliance admin, wherein the short sale proceeds are converted into the cryptocurrency of the equivalent value; executing at least one short cover buy order corresponding to the executed short sale to buy back the aggregate inventory accounts sold during the short sale; and displaying, on the borrower dashboard, a margin timer representing a time left to maintain a margin in a master account of the borrower when a margin call is initiated.

Embodiments of the present invention may provide a digital asset lending system for borrower, the fund managers of borrowers, and hedge fund managers to hedge the digital assets through a short sale in a familiar manner that is both compliant and conforms to industry norms.

Embodiments of the present invention may provide a digital asset lending system for borrowing and hedging of digital assets and/or traditional assets in compliance with Regulation SHO, Regulation T, Financial Industry Regulatory Authority (FINRA) rule 4210, and additional broker dealer compliance requirements.

Embodiments of the present invention may provide a digital asset lending system for borrowing and hedging of digital assets and/or traditional assets in one-click using the closed custody network that replaces the requirement for Depository Trust & Clearing Corporation (DTCC) clearance.

Embodiments of the present invention may provide a number of advantages depending on its particular configuration. It is an object of the present invention to provide a system and method to provide a digital asset lending system for borrowing and hedging of digital assets and/or traditional assets in a regulation compliance framework.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIG. 1 illustrates a block diagram of a digital asset lending system, according to embodiments of the present invention disclosed herein;

FIG. 2 illustrates components of a lending platform of the digital asset lending system, according to embodiments of the present invention disclosed herein;

FIG. 3 illustrates a system architecture of the digital lending system, according to embodiments of the present invention disclosed herein;

FIG. 4 illustrates an exemplary user interface displaying notifications on the user device, according to embodiments of the present invention disclosed herein;

FIG. 5 illustrates a closed custody lending network of the digital asset lending system, according to embodiments of the present invention disclosed herein;

FIG. 6 illustrates a distributed lending connectivity of the digital asset lending system, according to embodiments of the present invention disclosed herein;

FIG. 7 illustrates an exemplary lender dashboard of the user device, according to an embodiment of the present invention;

FIG. 8A illustrates an exemplary borrower dashboard, according to an embodiment of the present invention;

FIG. 8B illustrates an exemplary borrower dashboard for executing a short sale using a one-click tab, according to an embodiment of the present invention; and

FIG. 9 illustrates a flowchart of a process for lending a digital asset using the digital asset lending system, according to embodiments of the present invention disclosed herein.

While embodiments of the present invention are described herein by way of example using several illustrative drawings, those skilled in the art will recognize the present invention is not limited to the embodiments or drawings described. It should be understood the drawings and the detailed description thereto are not intended to limit the present invention to the particular form disclosed, but to the contrary, the present invention is to cover all modification, equivalents and alternatives falling within the spirit and scope of embodiments of the present invention as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention will be described below in conjunction with exemplary digital asset lending system. Embodiments of the present invention are not limited to any particular type of digital asset lending system. Those skilled in the art will recognize the disclosed techniques may be used in any digital asset lending system in which it is desirable to lend one or more digital assets.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation or technique.

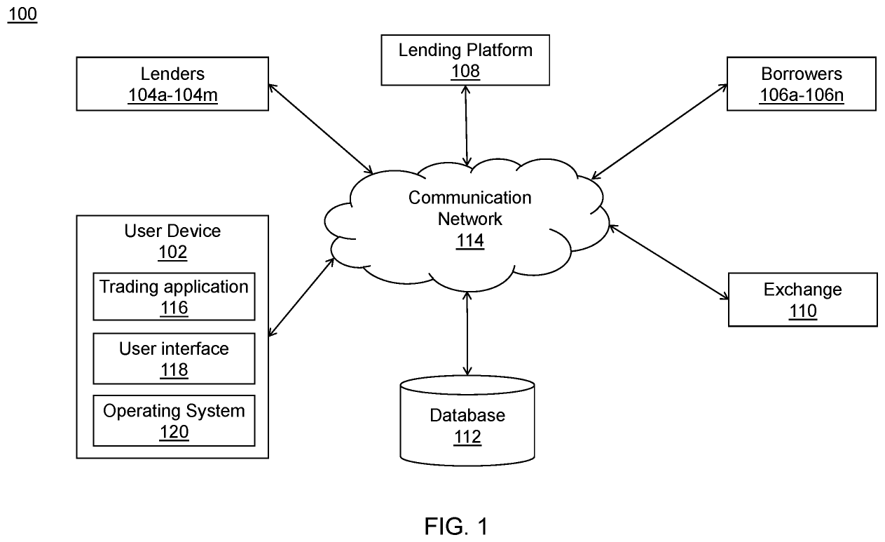

FIG. 1A illustrates a block diagram of a digital asset lending system 100, according to embodiments of the present invention. The digital asset lending system 100 comprises a user device 102, a plurality of lenders 104a-104m (hereinafter referred to as the lender 104), a plurality of borrowers 106a-106n (hereinafter referred to as the borrower 106), a lending platform 108, an exchange 110, and a database 112. Further, the user device 102, the lender 104, the borrower 106, the lending platform 108, the exchange 110, and the database 112 may be connected through a communication network 114, according to embodiments of the present invention.

The communication network 114 may include a data network such as, but not limited to, the Internet, Local Area Network (LAN), Wide Area Network (WAN), Metropolitan Area Network (MAN), etc. In some embodiments of the present invention, the communication network 114 may include a wireless network, such as, but not limited to, a cellular network and may employ various technologies including an Enhanced Data Rates For Global Evolution (EDGE), a General Packet Radio Service (GPRS), etc. In some embodiments of the present invention, the communication network 114 may include or otherwise cover networks or sub-networks, each of which may include, for example, a wired or a wireless data pathway. Examples of the communication network 114 may further include, but are not limited to, a Personal Area Network (PAN), a Storage Area Network (SAN), a Home Area Network (HAN), a Campus Area Network (CAN), a Virtual Private Network (VPN), an Enterprise Private Network (EPN), Internet, a Global Area Network (GAN), and so forth. Embodiments of the present invention are intended to include or otherwise cover any type of network, including known, related art, and/or later developed technologies to connect components of the digital asset lending system 100. According to an embodiment of the present invention, the user device 102, the lender 104, the borrower 106, the lending platform 108, the exchange 110, and the database 112 may be configured to communicate with each other by one or more communication mediums connected to the communication network 114. The communication mediums may include, but are not limited to, a coaxial cable, a copper wire, a fiber optic, a wire that comprise a system bus coupled to a processor of a computing device, and so forth. Embodiments of the present invention are intended to include or otherwise cover any type of communication medium, including known, related art, and/or later developed technologies.

The user device 102 may be, but not limited to, a mobile device, a smart phone, a tablet computer, a portable computer, a laptop computer, and so forth. Embodiments are intended to include or otherwise cover any type of user device 102, including known, related art, and/or later developed technologies. According to embodiments of the present invention, the user device 102 may enable a user to transmit and receive data within the digital asset lending system 100. According to embodiments of the present invention, the user may be, but not limited to, the lender 104, the borrower 106, a third party service provider, and so forth. In an embodiment of the present invention, the lender 104 may be, but not limited to, an exchange, a custodian partner, an inventory provider, a broker, and so forth. According to an embodiment of the present invention, the borrower 106 may be, but not limited to, an asset manager, a client of the asset manager, a hedge fund manager, a family office, an institutional client of the lender 104, and so forth.

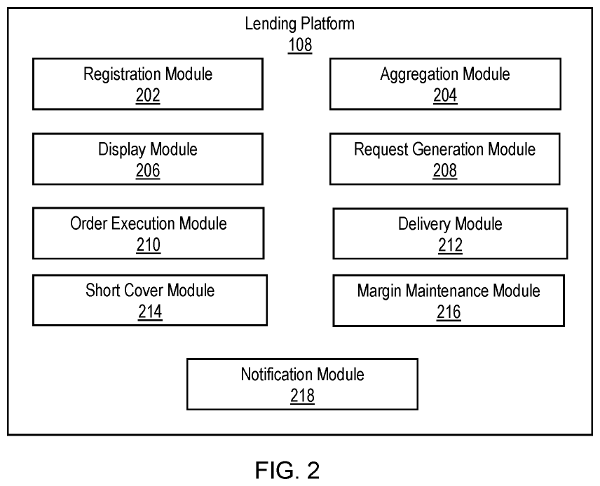

Further, the user device 102 may comprise one or more software applications such as, but not limited to, an ecommerce application, a location-based service application, a navigation application, a camera/imaging application, a media player application, a social networking application, a financial application, and so forth. Embodiments of the present invention are intended to include or otherwise cover any type of the software applications including known, related art, and/or later developed technologies. In an embodiment of the present invention, the user device 102 may include a trading application 116. The trading application 116 may be configured to enable the user to access data and/or input data within the digital asset lending system 100, according to embodiments of the present invention. Further, in an embodiment of the present invention, the trading application 116 may be managed by the lending platform 108 through the communication network 114. In an embodiment of the present invention, the lending platform 108 may be a computer readable program provided in the user device 102. In another embodiment of the present invention, the lending platform 108 may be implemented as a hardware, a firmware, a software, or a combination thereof managed by a third-party service provider (not shown). Further, the lending platform 108 is explained below in more detail in conjunction with FIG. 2.

According to embodiments of the present invention, the user device 102 further comprises a user interface 118. The user interface 118 may be configured to enable the user to input data, according to embodiments of the present invention. The user interface 118 may be further configured to display output data received from the lending platform 108 of the digital asset lending system 100, in an embodiment of the present invention. The user interface 118 maybe, but is not limited to, a digital display, a touch screen display, a graphical user interface, and so forth. Embodiments of the present invention are intended to include or otherwise cover any type of the user interface 118 including known, related art, and/or later developed technologies that may be capable of enabling the user to input data and to display output data. In addition, the user device 102 may include, but not limited to, an operating system 120, a memory (not shown) for storing the operating system 120, a control logic, and other application software providing secondary functionality, an input-output interfaces such as, but not limited to, a keyboard, a mouse, a printer, a display unit, and so forth, according to embodiments of the present invention.

According to embodiments of the present invention, the user device 102 may be configured to be used by the lender 104, the borrower 106, the third party service provider, and so forth for communicating with each other and for communicating with the other components of the digital asset lending system 100. In an embodiment of the preset invention, the third party service provider may be, but is not limited to, an institutional Broker-Dealer (BD) partner, a distribution partner, a Collateral Manager, and so forth. Embodiments of the present invention are intended to include or otherwise cover any type of the third party service provider capable of providing assistance in lending and/or borrowing a digital asset and/or a traditional asset.

According to embodiments of the present invention, the digital asset lending system 100 further comprises the database 112 for storage and retrieval of data associated with the digital asset lending system 100. According to embodiments of the present invention, the database 112 may be, but is not limited to, a centralised database, a distributed database, a personal database, an end-user database, a commercial database, a Structured Query Language (SQL) database, a Non-SQL database, an operational database, a relational database, a cloud database, an object-oriented database, a graph database, and so forth. Embodiments of the present invention are intended to include or otherwise cover any type of the database 112 including known, related art, and/or later developed technologies that may be capable of data storage and retrieval.

FIG. 2 illustrates components of the lending platform 108 of the digital lending system 100, according to embodiments of the present invention. The lending platform 108 may include, but not limited to, a registration module 202, an aggregation module 204, a display module 206, a request generation module 208, an order execution module 210, a delivery module 212, a short cover module 214, a margin maintenance module 216, and a notification module 218, in an embodiment of the present invention. According to embodiments of the present invention the digital asset lending system 100 may be configured to assign a compliance admin (not shown) for the lending platform 108. The compliance admin may be capable of handling a plurality of operations associated with the lending platform 108 using an admin dashboard displayed on the user device 102 of the compliance admin.

The registration module 202 may be configured to enable a user of the digital asset lending system 100 to register into the trading application 116 by using the user device 102. In an embodiment of the present invention, the user may be, but not limited to, the lender 104, the borrower 106, the third party service provider, the compliance admin, and so forth. Further, the registration module 202 may be configured to display a login page (not shown) on the user interface 118 of the user device 102, in an embodiment of the present invention.

According to an embodiment of the present invention, the registration module 202 in communication with the user interface 118 may enable the user to register as the lender 104 by providing lender registration data. In an embodiment of the present invention, the lender 104 may be, but not limited to, a lending entity, a collateral manager, an exchange, an inventory provider, a Custodian Partner (CP) of the inventory provider, a broker, and so forth. In an exemplary scenario, if the lender 104 is the lending entity, the collateral manager, the exchange, or the custodian partner of an inventory provider, then the lender registration data may include, but not limited to, a company data, an interest rate, a master inventory account details, and so forth. In another exemplary scenario, if the lender 104 is the inventory provider or the broker, then the lender registration data may include, but not limited to, company data, custodian partner details, an interest rate, the master inventory account details, and so forth. Further, the custodian partner may be a financial institution capable of safely holding an inventory account of a client, according to embodiments of the present invention. According to embodiments of the present invention, the company data may include, but not limited to, a name of the company, a location, a contact number, an address, a management details of the company, and so forth. In an embodiment of the present invention, the custodian partner detail may comprise data such as, but not limited to, a custodian partner location, a custodian partner name, a custodian partner contact number, a custodian partner registration number, and so forth. In an embodiment of the present invention, the lender 104 may be capable of funding the master inventory account with an inventory of digital assets and/or traditional assets. The master inventory account may further comprise a first inventory sub-account, and a third inventory sub-account, in an embodiment of the present invention. According to embodiments of the present invention, the first inventory sub-account may include an inventory of long positions and cash details associated with the lender 104. Further, the first inventory sub-account may be directly owned by the lender 104, in an embodiment of the present invention. The inventory of long positions may include, but not limited to, a list of digital assets, a quantity of each of the digital assets, a ticker symbol associated with each of the digital assets, a price of each of the digital assets, a list of traditional assets, a quantity of each of the traditional assets, a ticker symbol associated with each of the traditional assets, a price of each of the traditional assets, and so forth. According to embodiments of the present invention, the third inventory sub-account may reflect an inventory lent out by the lender 104 to a borrower 106 within the digital asset lending system 100. Further, the third inventory sub-account may be directly owned by a collateral manager for benefits of the lender 104. According to an embodiment of the present invention, the third inventory sub-account may include, but not limited to, a list of digital assets, a quantity of each of the digital assets, a ticker symbol associated with each of the digital assets, a price of each of the digital assets, a list of traditional assets, a quantity of each of the traditional assets, a ticker symbol associated with each of the traditional assets, a price of each of the traditional assets, and so forth.

Further, the registration module 202 may be configured to enable the lender 104 to generate a lender login credential. The lender login credential may comprise a lender identifier (ID) and a password, in an embodiment of the present invention. According to embodiments of the present invention, the lender ID and password may comprise, but not limited to, a letter, a special character, a number, or a combination thereof. The lender login credential may be used by the lender 104 for logging into the trading application 116 of the digital asset lending system 100, in an embodiment of the present invention. Further, the registration module 202 may be configured to store the lender registration data and the lender login credential into the database 112 of the digital asset lending system 100.

According to another embodiment of the present invention, the registration module 202 in communication with the user interface 118 may enable the user to register as the borrower 106 by providing borrower registration data. According to an embodiment of the present invention, the borrower 106 may be, but not limited to, an asset manager, a client of the asset manager, a hedge fund manager, a family office, an institutional client of the lender 104, and so forth. According to embodiments of the present invention, the borrower registration data may include, but not limited to, a borrower compliance detail, an asset manager compliance detail, a location of a custodian partner of the borrower 106, a plurality of third party service providers associated to the borrower 106, a master inventory account, and so forth. Embodiments of the present invention are intended to include or otherwise cover any type of the borrower registration data that may be beneficial for borrowing at least one of the inventories available within the digital asset lending system 100.

In an embodiment of the present invention, the borrower 106 may be capable of funding the master inventory account. The master inventory account may further comprise a first sub-account, a second sub-account, and a third sub-account, in an embodiment of the present invention. The first sub-account may include an inventory of long positions and cash details. Further, the first sub-account may be directly owned by the lender 104, or the hedge fund manager, in an embodiment of the present invention. The second sub-account may comprise an inventory of executed short sale that is executed by the hedge fund manager on behalf of the borrower 106. Further, the second sub-account may be directly owned by the hedge fund manager, in an embodiment of the present invention. The third sub-account may reflect an inventory lent out by the lender 104 within the digital asset lending system 100. Further, the third inventory sub-account may be directly owned by a collateral manager for benefits of the lender 104.

Further, the registration module 202 may be configured to enable the borrower 106 to generate a borrower login credential. The borrower login credential may comprise a borrower identifier (ID) and a password, in an embodiment of the present invention. According to embodiments of the present invention, the borrower ID and password may comprise, but not limited to, a letter, a special character, a number, or a combination thereof. The borrower login credential may be used by the borrower 106 for logging into the trading application 116 of the digital asset lending system 100, in an embodiment of the present invention. Further, the registration module 202 may be configured to store the borrower registration data and the borrower login credential into the database 112 of the digital asset lending system 100.

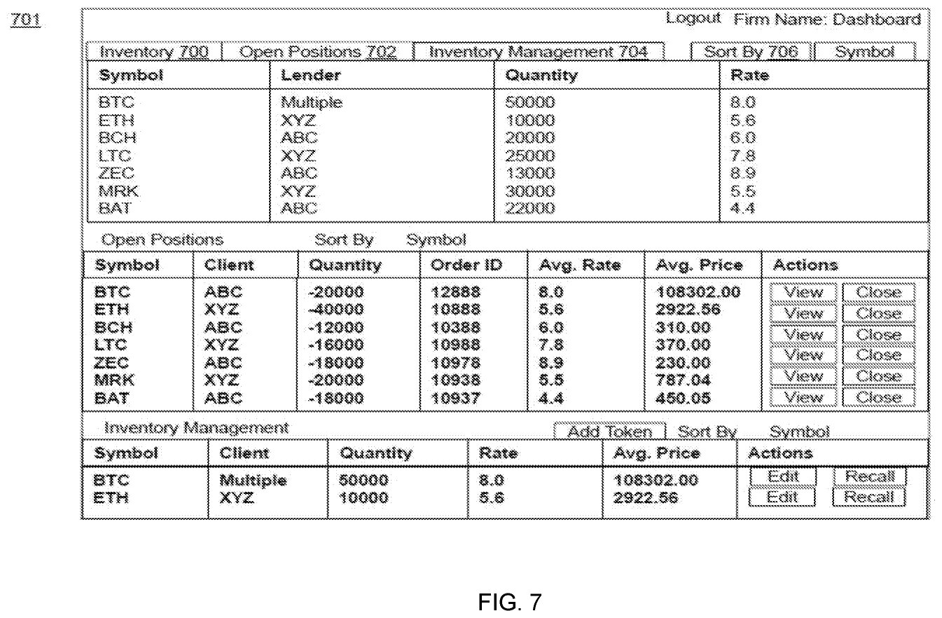

According to embodiments of the present invention, the registration module 202 in communication with the user interface 118 may enable the lender 104 to login into the trading application 116 of the digital lending system 100. The registration module 202 may be configured to prompt the lender 104 to enter a lender login credential for logging into the digital asset lending system 100 through the trading application 116. According to embodiments of the present invention, the registration module 202 may be further configured to authenticate the lender 104 by comparing the entered lender login credential with a plurality of lender login credentials stored in the database 112 of the digital asset lending system 100. In an embodiment of the present invention, if the registration module 202 determines that the entered lender login credential matches with the lender login credential stored in the database 112, then a lender dashboard 701 is displayed on the user device 102 (as shown in FIG. 7). In an embodiment of the present invention, the lender dashboard 701 may comprise options such as, but not limited to, an inventory tab 700, an open position tab 702, an inventory management tab 704, a sort tab 706, and so forth. Further, the lender dashboard 701 may be configured to display details of an order, view an order summary, close an order, and so forth.

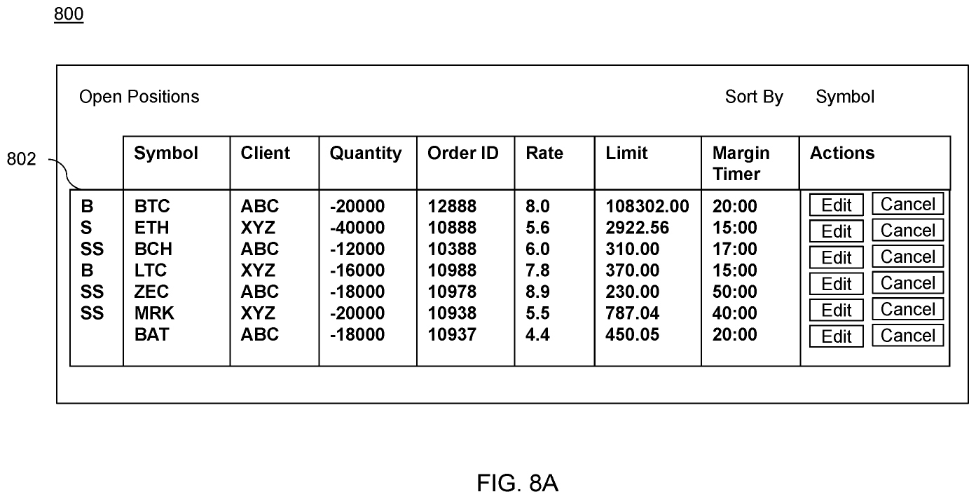

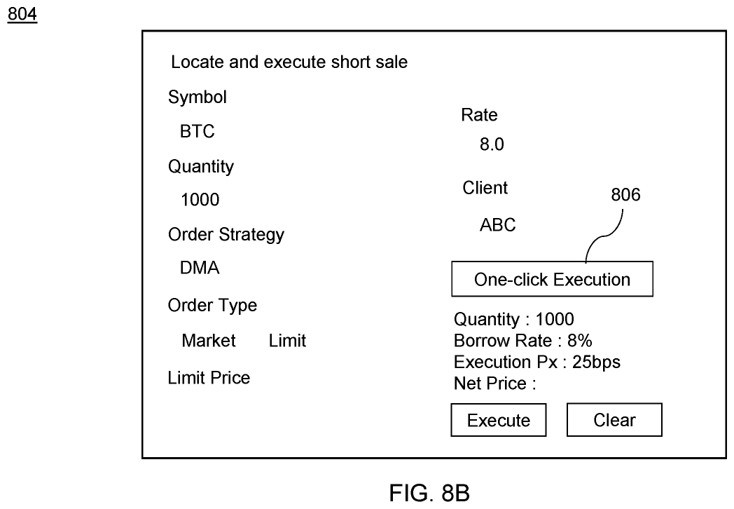

According to embodiments of the present invention, the registration module 202 in communication with the user interface 118 may enable the borrower 106 to login into the trading application 116 of the digital asset lending system 100. The registration module 202 may be configured to prompt the borrower 106 to enter a borrower login credential for logging into the digital asset lending system 100 through the trading application 116. According to embodiments of the present invention, the registration module 202 may be further configured to authenticate the borrower 106 by matching the entered borrower login credential with a plurality of borrower login credentials stored in the database 112 of the digital asset lending system 100. In case, the registration module 202 determines a match for the entered borrower login credential in the database 112, then a borrower dashboard 800 (as shown in FIG. 8A) is displayed on the user device 102 of the borrower 106. In an embodiment of the present invention, the borrower dashboard 800 may comprise a plurality of options such as, but not limited to, a ticker symbol of a digital asset, a client name, a quantity of the digital assets, an order identifier, an interest rate, a limit, a margin timer, an edit order tab, a cancel tab, and so forth. In an embodiment of the present invention, the borrower dashboard 800 may further comprise a one-click execute tab, a locate tab, an initiate borrow tab, a risk book tab, a buy-in tab, a recall tab, a close-out tab, a margin timer, a compliance regulation for margin tab, a compliance regulation for collateral tab, an alert tab, a client's client view tab, a profit and loss indicator, a reporting tab, a corporate actions tab, and so forth.

The aggregation module 204 may be configured to aggregate a plurality of inventory accounts of the lender 104 stored in the database 112. According to an embodiment of the present invention, the aggregate inventory accounts may comprise a master inventory account and a third inventory sub-account of each of the lenders 104. In an embodiment of the present invention, the aggregation module 204 may be configured to fetch the aggregate inventory accounts from the database 112 based on a location of a custodian partner of the lender 104 and a location of a custodian partner of the borrower 106. In an embodiment of the present invention, the lender 104 may act as the custodian partner of the lender 104. In an embodiment of the present invention, the borrower 106 may be the custodian partner of the borrower 106. In an exemplary scenario, if the location of the custodian partner of the lender 104 matches with the location of the custodian partner of the borrower 106, then the aggregation module 204 may be configured to fetch matched plurality of aggregate inventory accounts from the database 112. In an embodiment of the present invention, the aggregation module 204 may be further configured to sort the fetched plurality of aggregate inventory accounts to be reflected in, but not limited to, a First-In First-Out (FIFO) form, a collateral manager ranking, and so forth. In an embodiment of the present invention, the fetched plurality of aggregate inventory accounts may be sorted based on an interest rate charged by the lender 104 associated with the aggregate inventory account. In an embodiment of the present invention, the sorted plurality of aggregate inventory accounts may be further sorted based on, but not limited to, the ticker symbol of each of the digital assets included in the aggregate inventory accounts, a current notional size of the aggregate inventory accounts, and so forth.

Further, the aggregation module 204 may be configured to transmit the sorted plurality of aggregate inventory accounts to the display module 206, in an embodiment of the present invention. According to embodiments of the present invention, the display module 206 may be configured to communicate with the user interface 118 of the user device 102 to display the sorted plurality of aggregate inventory accounts on the borrower dashboard 800. According to embodiments of the present invention, the user interface 118 may display, but not limited to, the aggregate inventory accounts, the sorted digital assets based on the ticker symbol included in each of the aggregate inventory accounts, the current notional size of each of the aggregate inventory accounts, and so forth.

The request generation module 208 may be configured to enable the borrower 106 to initiate a borrow by entering a total borrow amount through the borrower dashboard 800. In an embodiment of the present invention, the request generation module 208 may be configured to display a minimum amount of collateral required to execute the borrow on the borrower dashboard 800 based on the total borrow amount entered by the borrower 106. In an embodiment of the present invention, the minimum required collateral may be in compliance with Regulation T (reg T) that governs cash accounts of the borrower 106. The minimum required collateral may be 50% of the total borrow amount entered by the borrower 106, according to an embodiment of the present invention. In another embodiment of the present invention, the minimum required collateral may be 15% of the total borrow amount entered by the borrower 106. In yet another embodiment of the present invention, the minimum required collateral may be 120% of the total borrow amount entered by the borrower 106. In an embodiment of the present invention, the minimum required collateral may be any defined percentage based on risk and regulatory set-up. Further, the request generation module 208 may be configured to enable the borrower 106 to submit the minimum required collateral using the borrower dashboard 800 to the digital asset lending system 100. In another embodiment of the present invention, the request generation module 208 may be configured to enable the borrower 106 to submit an equivalent amount of cryptocurrency as a minimum required collateral by using a third party service provider. The cryptocurrency may be, but not limited to, a bit coin, an alt coin, a Gemini dollar (GUSD), and so forth. Embodiments of the present invention are intended to include or otherwise cover any type of the cryptocurrency, including known, related art, and/or later developed technologies. In a preferred embodiment of the present invention, the cryptocurrency may be a stable coin that may be pegged to a cryptocurrency, a fiat money, an exchange traded commodity, and so forth. In another embodiment of the present invention, the request generation module 208 may be configured to enable the borrower 106 to submit the minimum required collateral by using a payment method such as, but not limited to, a credit card, a debit card, an online wallet, and so forth. Embodiments of the present invention are intended to include or otherwise cover any type of the payment method, including known, related art, and/or later developed technologies.

According to an embodiment of the present invention, the request generation module 208 may further be configured to enable the borrower 106 to generate a short sale execution signal using the one-click tab 806 available on the borrower dashboard 800 (as shown in FIG. 8B) after the request generation module 208 determines a successful submission of the minimum required collateral, in an embodiment of the present invention. The request generation module 208 may be further configured to enable the lender 104 to receive the minimum required collateral that may be displayed on the lender dashboard 701, according to an embodiment of the present invention. The lender 104 may receive the minimum required collateral in an equivalent amount of cryptocurrency, in an embodiment of the present invention. The cryptocurrency may be, but not limited to, a bit coin, an alt coin, a Gemini dollar (GUSD), and so forth. Embodiments of the present invention are intended to include or otherwise cover any type of the cryptocurrency, including known, related art, and/or later developed technologies. In a preferred embodiment of the present invention, the cryptocurrency may be a stable coin that may be pegged to a cryptocurrency, a fiat money, an exchange traded commodity, and so forth. In another embodiment of the present invention, the request generation module 208 may be configured to enable the borrower 106 to generate a short sale execution signal using a locate tab (not shown). The request generation module 208 may be configured to enable the borrower 106 to generate the short sale execution signal by entering data such as, but not limited to, a ticker symbol of a digital asset, an interest rate, a quantity of the digital asset, an order strategy, a client name, an order type, a limit price, and so forth (as shown in FIG. 8B). Further, the request generation module 208 may be configured to transmit the generated short sale execution signal to the order execution module 210, according to embodiments of the present invention.

According to an embodiment of the present invention, the short sale execution signal may be configured to enable the order execution module 210 that may further be configured to generate a locate request corresponding to the data entered by the borrower 106. The locate request may be configured to locate an availability of an aggregate inventory account, a price for borrow rate, and a price for an execution rate corresponding to the data entered by the borrower 106, in an embodiment of the present invention. The order execution module 210 may be configured to execute the locate request in compliance with a Regulation Sho 203, in an embodiment of the present invention.

Further, the order execution module 210 may be configured to determine a short sale rate by combining both the borrow rate and the execution rate when aggregate inventory accounts are located, in an embodiment of the present invention. Furthermore, the order execution module 210 may be configured to generate a contract for the lender 104 and the borrower 106, in an embodiment of the present invention. The contract may comprise data such as, but not limited to, the total borrow amount, the minimum required collateral submitted by the borrower 106, a detail of the aggregate inventory account to be borrowed by the borrower 106, the interest rate, and so forth. Embodiments of the present invention are intended to include or otherwise cover any type of the data of the contract, including known, related art, and/or later developed technologies. According to embodiments of the present invention, the order execution module 210 may be configured to store the generated contract in the database 112 of the digital asset lending system 100.

In an embodiment of the present invention, the short sale execution signal may be further configured to enable the order execution module 210 to execute a short sale of the located aggregate inventory accounts at the exchange 110 of the digital asset lending system 100. According to embodiments of the present invention, the executed short sale may be executed in compliance with a Regulation Sho 200, a Regulation Sho 201, and Regulation Sho 204. According to embodiments of the present invention, a total settlement time of a short sale may be trading day (T) plus 30 minutes (T+30 min). Further, the order execution module 210 may be configured to receive short sale proceeds from the exchange 110 generated by the short sale of the located aggregate inventory accounts, in an embodiment of the present invention. Further, the order execution module 210 may be configured to transmit the received short sale proceeds to the delivery module 212.

According to an embodiment of the present invention, the delivery module 212 may be configured to convert the received short sale proceeds into an equivalent amount of fiat money. The fiat money may be a currency such as, but not limited to, a United States Dollar (USD) that may be issued by a government body and is not backed by a commodity, according to embodiments of the present invention. In another embodiment of the present invention, the delivery module 212 may be configured to convert the received short sale proceeds into an equivalent amount of cryptocurrency. According to embodiments of the present invention, the cryptocurrency may be, but not limited to, a bit coin, an alt coin, a Gemini dollar (GUSD), and so forth. Embodiments of the present invention are intended to include or otherwise cover any type of the cryptocurrency, including known, related art, and/or later developed technologies. In a preferred embodiment of the present invention, the cryptocurrency may be a stable coin that may be pegged to a cryptocurrency, a fiat money, an exchange traded commodity, and so forth.

Further, the delivery module 212 may be configured to deliver 100% of the converted short sale proceeds to a collateral manager and/or the lender 104, the short cover module 214, and the compliance admin of the lending platform 108, in an embodiment of the present invention. The delivered short sale proceeds may be displayed through the admin dashboard on the user device 102 of the compliance admin. Further, the delivery module 212 may enable the compliance admin of the lending platform 108 to determine a lending return for the lender 104 from the received short sale proceeds based on the interest rate charged by the lender 104, in an embodiment of the present invention. The delivery module 212 may be further configured to enable the compliance admin to transmit the determined lending return to the lender 104 as equivalent amount of cryptocurrency. According to embodiments of the present invention, the cryptocurrency may be, but not limited to, a bit coin, an alt coin, a Gemini dollar (GUSD), and so forth. Embodiments of the present invention are intended to include or otherwise cover any type of the cryptocurrency, including known, related art, and/or later developed technologies. In a preferred embodiment of the present invention, the cryptocurrency may be a stable coin that may be pegged to a cryptocurrency, a fiat money, an exchange traded commodity, and so forth. According to embodiments of the present invention, the compliance admin of the lending platform 108 may further determine economics for a plurality of parties such as, but not limited to, the collateral manager, the custodian partner, and the lending platform 108 based on the received short sale proceeds, and so forth.

According to embodiments of the present invention, the short cover module 214 may be configured to perform a risk management associated with the executed short sale. The short cover module 214 may be configured to execute short cover buy order at the exchange 110 of the digital asset lending system 100 based on a real-time price movement of the digital assets associated with shorted aggregate inventory accounts, in an embodiment of the present invention. Further, the short cover module 214 may be configured execute a short cover buy order at the exchange 110 of the digital asset lending system 100 using currency such a, but not limited to, United States Dollar (USD). The short cover buy order may be executed to buy back the aggregate inventory accounts that was sold during the short sale executed by the order execution module 210, according to an embodiment of the present invention. In an exemplary scenario, if the short sale executed by the order execution module 210 comprises an aggregate inventory account with 100 digital assets, then the short cover module 214 may be configured to execute the short cover buy order comprising an aggregate inventory account including 100 digital assets to cover the short sale. Further, the short cover module 214 may be configured to receive short cover proceeds from the exchange 110 generated by the execution of the short cover buy order. According to embodiments of the present invention, the short cover module 214 may be configured to determine a profit and/or a loss based on the received short cover proceeds. According to embodiments of the present invention, a total settlement time from of a short cover buy order may be trading day (T) plus 30 minutes (T+30 min).

Further, the short cover module 214 may be configured to transmit the determined profit and/or the loss and the bought back aggregate inventory account through the short cover buy order to the margin maintenance module 216, in an embodiment of the present invention.

The margin maintenance module 216 may be configured to determine an amount required to maintain a margin in the master account of the borrower 106 based on the determined profit and/or the loss. In an embodiment of the present invention, the maintenance margin required in the account of the borrower 106 may be 30% maintenance margin that may be in compliance with Financial Industry Regulatory Authority (FINRA) rule number 4210. In another embodiment of the present invention, the maintenance margin required in the account of the borrower 106 may be exempted in compliance with Financial Industry Regulatory Authority (FINRA) rule number 4210. According to embodiments of the present invention, the margin maintenance module 216 may enable the borrower 106 to maintain the margin by funding the master account of the borrower 106 with an equivalent amount of cryptocurrency. In an embodiment of the present invention, the cryptocurrency may be, but not limited to, a bit coin, an alt coin, a Gemini dollar (GUSD), and so forth. Embodiments of the present invention are intended to include or otherwise cover any type of the cryptocurrency, including known, related art, and/or later developed technologies. In a preferred embodiment of the present invention, the cryptocurrency may be a stable coin that may be pegged to a cryptocurrency, a fiat money, an exchange traded commodity, and so forth. Further, the margin maintenance module 216 may be configured to generate a margin timer that may be displayed on the borrower dashboard 800 (as shown in the FIG. 8A), according to embodiments of the present invention. In an embodiment of the present invention, the margin maintenance module 216 may enable the compliance admin of the lending platform 108 to set the margin timer in a range of 1 hour to 12 hours. In another embodiment of the present invention, the margin maintenance module 216 may enable the compliance admin of the lending platform 108 in communication with the collateral manager to set the margin timer according to a time defined by the collateral manager. In a preferred embodiment of the present invention, the margin timer may be set at 4 hours. Further, the margin maintenance module 216 may be configured to generate a margin alert that may be transmitted to the notification module 218. The margin alert may be configured to notify the borrower 106 that a margin call has been initiated, according to embodiments of the present invention. Further, the margin timer may notify the borrower 106 in real-time about a time remaining to satisfy the margin call by funding the master account of the borrower 106. Furthermore, the margin maintenance module 216 may be configured to transmit the received aggregate inventory accounts bought back by executing the short cover buy order to the aggregation module 204, in an embodiment of the present invention.

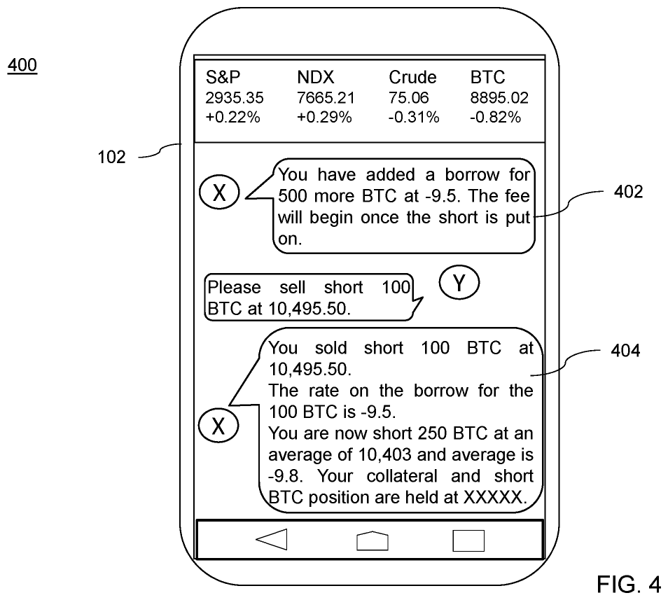

Further, the notification module 218 may be configured to generate a notification that may be capable of notifying the user about an action performed within the digital asset lending system 100. The actions may be, but not limited to, a requirement of minimum required collateral, a submission of the minimum required collateral, a short sale execution, a short cover buy order execution, and so forth. Further, the notification module 218 may be configured to transmit the generated notification to the user device 102 associated with the user through the communication network 114 of the digital asset lending system 100. Further, the transmitted notification may be displayed on the user interface 400 of the user device 102 (as shown in FIG. 4). According to embodiments of the present invention, the notification may be transmitted as, but not limited to, a text message, a voice message, a video message, and so forth. Embodiments of the present invention are intended to include or otherwise cover any type of the notification, including known, related art, and/or later developed technologies that may be capable of notifying the user about an action performed within the digital asset lending system 100.

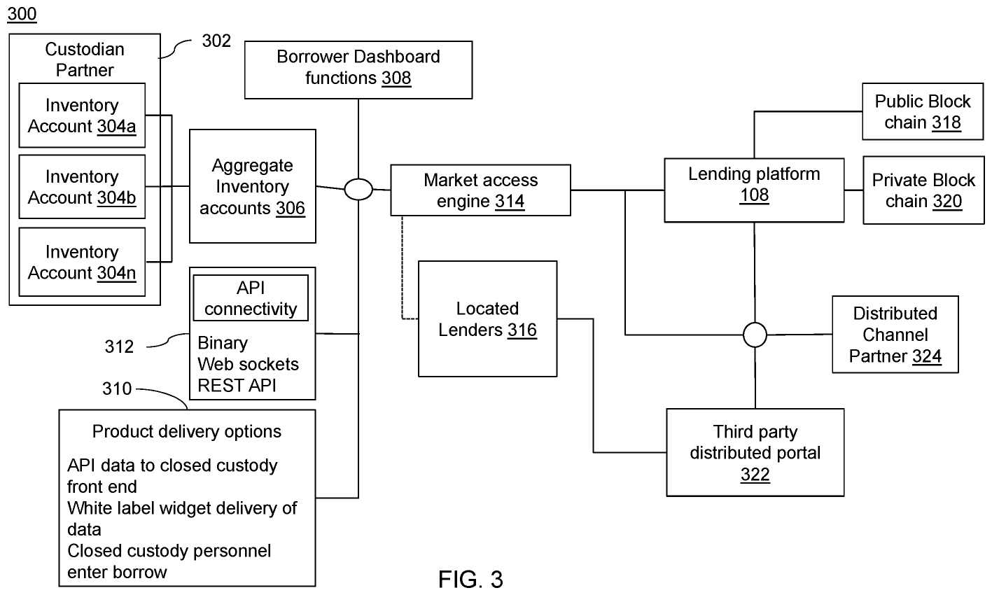

FIG. 3 illustrates a system architecture 300 of the digital asset lending system 100, according to an exemplary embodiment of the present invention. At block 302, the system architecture 300 may comprise a custodian partner of the lender 104 that may be capable of holding a plurality of inventory accounts 304a-304n of the lender 104. Further, the plurality of inventory accounts 304a-304n of the lenders 104 may be aggregated at block 306 and displayed on a borrower dashboard using the user interface 118 of the user device 102.

At block 308, the borrower dashboard may be configured to display a plurality of options such as, but not limited to, an initiate borrow tab configured to enable the borrower to initiate a borrow based on a generated borrow request, an available inventory configured to display an available inventory sorted according to an interest rate charged by the lender 104, a risk book tab configured to enable a third party service provider or the borrower 106 to monitor a risk associated with the lending process, a buy-in tab, a recall tab, a close out tab, a compliance regulation details associated with a margin, a compliance regulation details associated with a collateral, a compliance regulation details associated an alert, a client's client view tab, a profit & loss tab, a corporate actions tab, a registration tab for a compliance admin, and so forth. In an embodiment of the present invention, the borrower dashboard may be further configured to display a plurality of notifications associated with each action performed within the digital asset lending system 100 corresponding to the digital assets of the lender 104 and/or borrower 106 (as shown in the FIG. 4).

Further, the system architecture 300 may enable the digital asset lending system 100 to deliver data associated with the digital asset lending system 100 to closed custody front end at block 310. The closed custody may be a custodian partner that may also act as an exchange for the digital asset lending system 100, in an embodiment of the present invention. Further, referring to the block 310, the digital asset lending system 100 may deliver data associated with the digital assets to the borrower dashboard, as explained above. Further, the data delivery at the block 310 within the digital asset lending system 100 may be accomplished by using an Application Programming Interface (API) connectivity block 312, in an embodiment of the present invention. In an embodiment of the present invention, the API connectivity may be, but not limited to, a binary connectivity, a web socket connectivity, a Representational State Transfer (REST) API connectivity and so forth.

Further, the system architecture 300 comprises a market access engine partner 314 that may be configured to communicate with the institutional BD partners for providing a locate corresponding to the borrow that may be initiated by the borrower 106 or the custodian partner of the borrower 106 using the one-click tab provided on the borrower dashboard. The one-click tab may be clicked by the borrower 106 after the borrower 106 selects a ticker symbol and quantity associated with an aggregate inventory account that the borrower 106 desires to borrow. The one-click tab may be configured to locate an availability of the aggregate inventory account, a price for a borrow rate, a price for an execution rate, and generate a single short sale rate by combining both the borrow rate and the execution rate, in an embodiment of the present invention. Further, the digital asset lending system 100 may be configured to execute a short sale of the located aggregate inventory accounts from the matching located lenders 316. Further, the digital asset lending system 100 comprises the lending platform 108 that may be configured to perform functions such as, but not limited to, a registration of a client or a compliance admin, a borrow initiation, providing a Central Limit Borrow Book (CLOG), executing trade at the exchange 110, an order handling limits, providing access to cryptocurrency, providing access to traditional assets, providing a profit or a loss details, a risk management, reporting a ledger to a public block chain 318 network, reporting a ledger to a private block chain 320 network, and so forth.

Further, the digital asset lending system 100 may be configured to be integrated with a third party distribution portal 322 using a distributed channel partner 324 that may be configured to provide the lending platform 108 for the borrowers 106 and the lender 104 for lending and borrowing digital assets. The third party distribution portal 322 may be configured to provide options such as, but not limited to, a borrow request initiation, an available inventory, a risk book tab, a buy-in tab, a recall tab, a close out tab, a compliance regulation details associated with a margin, a compliance regulation details associated with a collateral, a compliance regulation details associated an alert, a client's client view tab, a profit & loss tab, a corporate actions tab, a registration tab for a compliance admin, and so forth. Further, the third party distribution portal 322 may be configured to report a ledger to the private block chain 320 network.

FIG. 4 illustrates an exemplary user interface 400 of the user device 102 displaying notifications, according to an embodiment of the present invention. When a user makes a borrow for 500 more BTC digital assets, then a notification 402 may be displayed on the user device 102. When the user sells 100 BTC digital assets, then a notification 404 may be displayed on the user device 102.

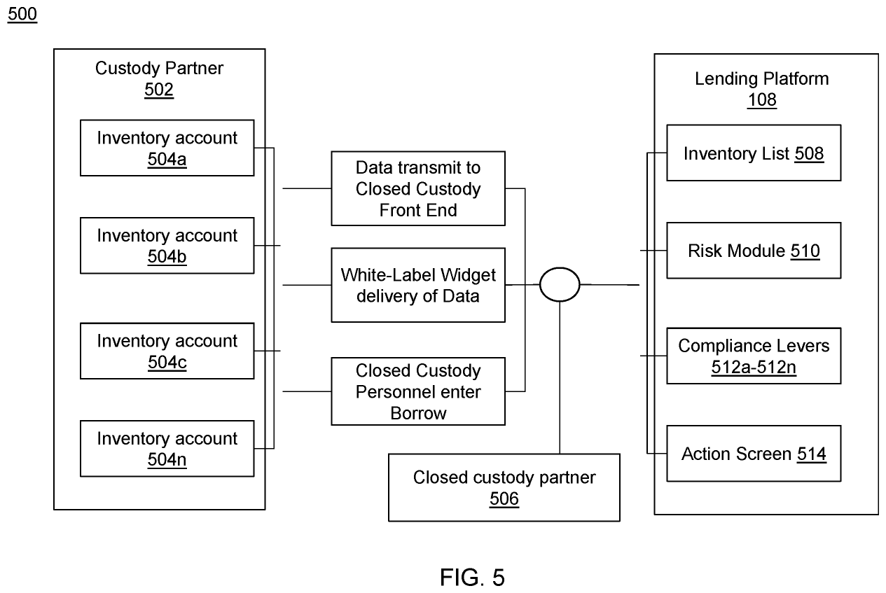

FIG. 5 illustrates a closed custody lending network 500 of the digital asset lending system 100, according to an embodiment of the present invention. The closed custody lending network 500 comprises a custody partner 502 that may be capable of holding a plurality of inventory accounts 504a-504n (hereinafter referred to as the inventory accounts 504) of the borrower 106, in an embodiment of the present invention. The custody partner 502 may be a bank, a financial institution, or so forth. Further, the borrower 106 may be, but not limited to, an asset manager, a hedge fund manager, an institutional investor, or so forth, according to embodiments of the present invention. According to embodiments of the present invention, the closed custody lending network 500 comprises a closed custody partner 506 that may be capable of executing trade associated with the digital asset lending system 100. Further, the closed custody partner 506 may be a custody partner of the lender 104, in an embodiment of the present invention. The closed custody partner 506 may be an exchange, in an embodiment of the present invention. According to embodiment of the present invention, the closed custody lending network 500 further includes the lending platform 108. The lending platform 108 may be configured to provide an inventory list 508, a risk management module 510, a plurality of compliance levers 512a-512n, an action screen 514, and so forth. Further, the custody partner 502, the exchange 506, the lending platform 108 may be configured to transmit and receive data associated with the digital asset lending system 100 using a third party Application Programming Interface (API) connectivity, in an embodiment of the present. The data may be transmitted to a front end of the closed custody partner 506 and the borrower dashboard using the API connectivity. In an embodiment of the present invention, the closed custody partner 506 may be configured to enter a borrow process using the API connectivity.

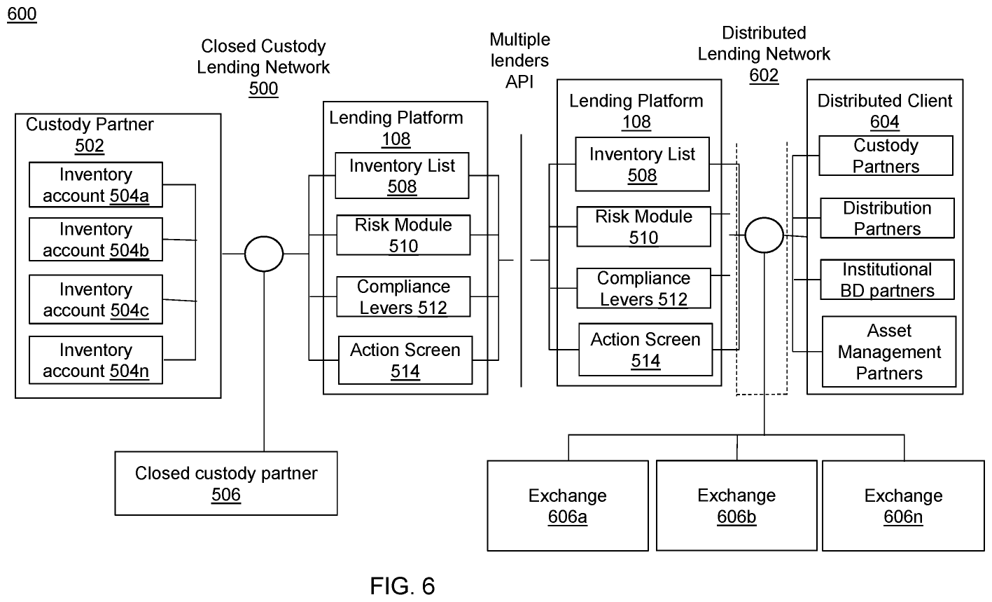

FIG. 6 illustrates a distributed lending connectivity 600 of the digital asset lending system 100, according to an embodiment of the present invention. The distributed lending connectivity 600 may comprise the closed custody lending network 500 (as shown in the FIG. 5) and a distributed lending network 602 connected through multiple lenders Application Programming Interface (API), in an embodiment of the present invention. The distributed lending network 602 may further comprise the lending platform 108 and a distributed client 604, according to embodiments of the present invention. The distributed client 604 may be a client that may have registered on the digital asset lending system 100 through the distributed channel partner 324 of the digital asset lending system 100. According to embodiments of the present invention, the client may be, but not limited to, the lender 104, the borrower 106, a third party service provider, and so forth. The distributed client 604 may be further connected with a plurality of third party service providers such as, but not limited to, a plurality of custody partners, a plurality of distribution partner, a plurality of institutional broker-dealer partners and a plurality of asset management partners. Further, the distributed lending network 602 may be connected to a plurality of exchanges 606a-606n, in an embodiment of the present invention. The connectivity for the plurality of exchanges 606a-606n may be granted to the distributed client 604 based on the distribution channel partner 324 at which the distributed client 604 has registered, according to embodiment of the present invention.

FIG. 7 illustrates an exemplary lender dashboard 701 of the user device 102, according to an embodiment of the present invention. The lender dashboard 701 may comprise options such as, but not limited to, an inventory tab 700, an open position tab 702, an inventory management tab 704, a sort tab 706, and so forth. Further, lender dashboard 701 may be configured to display details of an order, view an order summary, close an order, and so forth.

FIG. 8A illustrates an exemplary borrower dashboard 800, according to an embodiment of the present invention. The borrower dashboard 800 may display ticket side 802 for illustrating current status of open orders associated with the borrower 106. The ticket side 802 may comprise options such as, ‘Buy to Open’, ‘Buy to Cover’, ‘Sell Short’, ‘Short Long’, and so forth, in an embodiment of the present invention.

FIG. 8B illustrates an exemplary borrower dashboard 804 for executing a short sale using the one-click tab 806, according to an embodiment of the present invention. The data entered by the borrower 106 may include, but not limited to, a ticker symbol of a digital asset, an interest rate, a quantity of the digital asset, an order strategy, a client name, an order type, a limit price, and so forth, in an embodiment of the present invention.

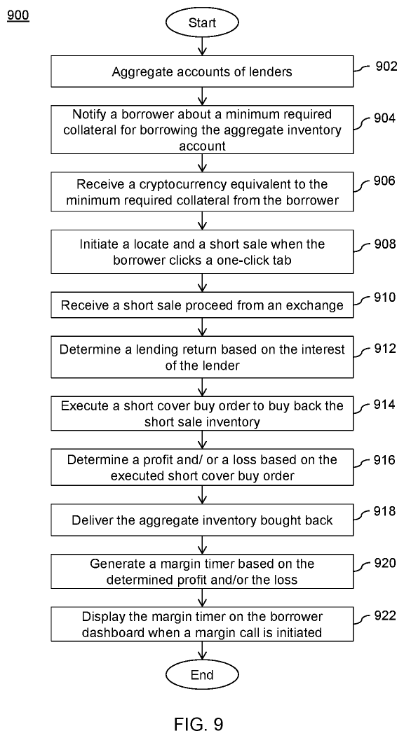

FIG. 9 illustrates a process 900 for lending a digital asset using the digital asset lending system 100, according to an embodiment of the present invention.

At step 902, the digital asset lending system 100 may aggregate a plurality of inventory accounts of the lenders 104. The digital asset lending system 100 may be configured to aggregate the plurality of inventory accounts by aggregating a main inventory account and a first inventory sub-account of each of the lenders 104. The aggregated plurality of inventory accounts may be sorted on the basis of an interest rate charged by the lenders 104 and displayed on a borrower dashboard, in an embodiment of the present invention.

At step 904, the digital asset lending system 100 may notify the borrower 106 about a minimum required collateral to be submitted before executing a short sale of the aggregate inventory accounts. In an embodiment of the present invention, the minimum required collateral may be equal to 50% of a total borrow amount. In another embodiment of the present invention, the minimum required collateral may be equal to 15% of the total borrow amount. In yet another embodiment of the present invention, the minimum required collateral may be equal to 120% of the total borrow amount. In an embodiment of the present invention, the minimum required collateral may be submitted as cryptocurrency. The cryptocurrency may be, but not limited to, a stable coin, a bit coin, an alt coin, a Gemini dollar (GUSD), and so forth.

At step 906, the digital asset lending system 100 may receive the minimum required collateral from the borrower 104 in the form of a cryptocurrency. In an embodiment of the present invention, the cryptocurrency may be, but not limited to, a stable coin, a bit coin, an alt coin, a Gemini dollar (GUSD), and so forth.

At step 908, the digital asset lending system 100 may enable the borrower 106 to initiate a locate, a borrow, and a short sale by using a one-click tab 806 from the borrower dashboard (such as the borrower dashboard 800) by entering data associated with the borrow of the aggregate inventory accounts.

At step 910, the digital asset lending system 100 may receive 100% of a short sale proceed generated by the short sale of the borrowed aggregate inventory accounts from the exchange 110. The received short sale proceeds may be converted to a cryptocurrency of an equivalent value. In an embodiment of the present invention, the cryptocurrency may be, but not limited to, a stable coin, a bit coin, an alt coin, a Gemini dollar (GUSD), and so forth. At step 912, the digital asset lending system 100 may determine a lending return for the lender 104 associated with the aggregate inventory account based on the interest rate charged by the lender 104. Further, the digital asset lending system 100 may deliver the lending return as cryptocurrency of an equivalent value to the lender 104. In an embodiment of the present invention, the cryptocurrency may be, but not limited to, a stable coin, a bit coin, an alt coin, a Gemini dollar (GUSD), and so forth.

At step 914, the digital asset lending system 100 may enable the borrower 106 to execute a short cover buy order at the exchange 110 corresponding to the executed short sale to buy back the aggregate inventory accounts sold during the execution of the short sale.

At step 916, the digital asset lending system 100 may determine a profit and/or a loss based on the executed short cover buy order. At step 918, the digital asset lending system 100 may deliver the aggregate inventory account bought back by executing the short cover buy order to the lender 104.

At step 920, the digital asset lending system 100 may generate a margin timer when a margin call is initiated based on the determined profit and/or the loss. At step 922, the digital asset lending system 100 may display the margin timer on the borrower dashboard that may notify the borrower 106 in real-time about a time left to satisfy a margin call. The borrower 106 may satisfy the margin call by funding the master account of the borrower 106 with an equivalent amount of cryptocurrency The cryptocurrency may be, but not limited to, a stable coin, a bit coin, an alt coin, a Gemini dollar (GUSD), and so forth.

The exemplary embodiments of this present invention have been described in relation to medical assistance. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

A number of variations and modifications of the present invention can be used. It would be possible to provide for some features of the present invention without providing others.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A digital asset lending system for lending and hedging one or more digital assets using a fiat currency or a cryptocurrency, the digital asset lending system comprising:
an aggregation module configured to aggregate a plurality inventory accounts of the one or more digital assets provided by a plurality of lenders;
a display module configured to display the plurality of aggregate inventory accounts associated with the plurality of lenders on a borrower dashboard based on a match between a location of the borrower and a location of each of the plurality of lenders;
a request generation module configured to enable a borrower to enter data associated with a borrow when a minimum required collateral to borrow at least one of the plurality of aggregate inventory accounts is received;
an order execution module configured to execute a short sale of at least one digital asset from one or more of the plurality of aggregate inventory accounts in response to an activation of a one-click tab provided on the borrower dashboard when the at least one received minimum required collateral is converted into the cryptocurrency of an equivalent value;
a delivery module configured to deliver a generated short sale proceeds of the short sale of the at least one of the plurality of aggregate inventory accounts to a collateral manager and a compliance admin, wherein the short sale proceeds are converted into a fiat currency of an equivalent value, or a cryptocurrency of an equivalent value;
a short cover module configured to execute at least one short cover buy order corresponding to the executed short sale to buy back the aggregate inventory accounts sold during the short sale; and
a margin maintenance module configured to display, on the borrower dashboard, a margin timer representing a time left to maintain a margin in a master account of the borrower when a margin call is initiated.

2. The system of claim 1, wherein the cryptocurrency is one of a stable coin, a bitcoin, an altcoin, a Gemini dollar (GUSD), or a combination thereof.

3. The system of claim 1, wherein the request generation module is further configured to enable at least one of a collateral manager to receive a request for the minimum required collateral from at least one hedge fund of the at least one client.

4. The system of claim 1, wherein the delivery module is further configured to deliver at least one lending return generated from the short sale of the aggregate inventory accounts to the lender of the aggregate inventory accounts.

5. The system of claim 1, wherein the margin maintenance module is further configured to enable the compliance admin to set the margin timer to 4 hours.

6. The system of claim 1, wherein the one-click tab is further configured to execute a locate for one or more of the plurality of aggregate inventory accounts before executing the short sale.

7. The system of claim 1, wherein the request generation module is further configured to sort the plurality of aggregate inventory accounts based on an interest rate charged by the lender associated with each of the plurality of aggregate inventory accounts.

8. A digital asset lending system for lending and hedging one or more digital assets using a fiat currency or a cryptocurrency, the digital asset lending system comprising:
an aggregation module configured to aggregate a plurality inventory accounts of the one or more digital assets provided by a plurality of lenders;
a display module configured to display the plurality of aggregate inventory accounts associated with the plurality of lenders on a borrower dashboard based on match between a location of the borrower and a location of each of the plurality of lenders;
a request generation module configured to enable a borrower to enter data associated with a borrow when a minimum required collateral to borrow at least one of the plurality of aggregate inventory accounts is received, wherein the minimum required collateral is one of a 15%, 50%, or 120% of a total borrow amount;
an order execution module configured to execute a short sale of at least one digital asset from one or more of the plurality of aggregate inventory accounts in response to an activation of a one-click tab provided on the borrower dashboard when the at least one received minimum required collateral is converted into the cryptocurrency of an equivalent value;
a delivery module configured to deliver a generated short sale proceeds of the short sale of the at least one of the plurality of aggregate inventory accounts to a collateral manager and a compliance admin, wherein the short sale proceeds are converted into a fiat currency of an equivalent value or the cryptocurrency of an equivalent value;
a short cover module configured to execute at least one short cover buy order corresponding to the executed short sale to buy back the aggregate inventory accounts sold during the short sale; and
a margin maintenance module configured to display, on the borrower dashboard, a margin timer representing a time left to maintain a margin in a master account of the borrower when a margin call is initiated.

9. The system of claim 8, wherein the cryptocurrency is one of a stable coin, a bitcoin, an altcoin, a Gemini dollar (GUSD), or a combination thereof.

10. The system of claim 8, wherein the request generation module is configured to enable at least one of a collateral manager to receive a request for the minimum collateral from at least one hedge fund of the at least one client.

11. The system of claim 8, wherein the delivery module is further configured to deliver at least one lending return generated from the short sale of the aggregate inventory accounts to the lender of the aggregate inventory accounts.

12. The system of claim 8, wherein the margin maintenance module is further configured to enable the compliance admin to set the margin timer to 4 hours.

13. The system of claim 8, wherein the one-click tab is further configured to execute a locate for one or more of the plurality of aggregate inventory accounts before executing the short sale.

14. The system of claim 8, wherein the request generation module is configured to sort the plurality of aggregate inventory accounts based on an interest rate charged by the lender associated with each of the plurality of aggregate inventory accounts.

15. A method for lending and hedging one or more digital assets using a fiat currency or a cryptocurrency, the method comprising steps of:
aggregating a plurality inventory accounts of the one or more digital assets provided by a plurality of lenders;
displaying the plurality of aggregate inventory accounts associated with the plurality of lenders on a borrower dashboard based on match between a location of the borrower and a location of each of the plurality of lenders;
enabling a borrower to enter data associated with a borrow when a minimum required collateral to borrow at least one of the plurality of aggregate inventory accounts is received;
executing a short sale of at least one digital asset from one or more of the plurality of aggregate inventory accounts in response to an activation of a one-click tab provided on the borrower dashboard when the at least one received minimum required collateral is converted into the cryptocurrency of an equivalent value;
delivering a generated short sale proceeds of the short sale of the at least one of the plurality of aggregate inventory accounts to a compliance admin, wherein the short sale proceeds are converted into a fiat currency of an equivalent value or the cryptocurrency of an equivalent value;
executing at least one short cover buy order corresponding to the executed short sale to buy back the aggregate inventory accounts sold during the short sale; and
displaying, on the borrower dashboard, a margin timer representing a time left to maintain a margin in a master account of the borrower when a margin call is initiated.

16. The method of claim 15, wherein the cryptocurrency is one of a stable coin, a bitcoin, an altcoin, a Gemini dollar (GUSD), or a combination thereof.

17. The method of claim 15, wherein the request generation module is further configured to enable at least one of a collateral manager to receive a request for the minimum required collateral from at least one hedge fund of the at least one client.

18. The method of claim 15, wherein the delivery module is further configured to deliver at least one lending return generated from the short sale of the aggregate inventory accounts to the lender of the aggregate inventory accounts.

19. The method of claim 15, wherein the margin maintenance module is further configured to enable the compliance admin to set the margin timer to 4 hours.

20. The method of claim 15, wherein the request generation module is further configured to sort the plurality of aggregate inventory accounts based on an interest rate charged by the lender associated with each of the plurality of aggregate inventory accounts.
